(19) United States
(12) Patent Application Publication
(10) Pub. No.: US 2012/0123955 A1
(43) Pub. Date: May 17, 2012

(54) CALCULATION ENGINE FOR COMPENSATION PLANNING

(76) Inventors: Ke (Kelly) CHEN, Foster City, CA (US); Si Yuan (Steven) Chen, Cupertino, CA (US); Xuejun Tao, San Jose, CA (US)

(21) Appl. No.: 13/294,935

(22) Filed: Nov. 11, 2011

Related U.S. Application Data
(60) Provisional application No. 61/413,323, filed on Nov. 12, 2010.

(51) Int. Cl. G06Q 10/06

(52) U.S. Cl. 705/320

(57) ABSTRACT

A method for managing compensation of users. The method includes identifying a first formula that is associated with a first compensation metric, where the first formula includes reference to a second compensation metric; computing a value for the second compensation metric based on evaluating a second formula associated with the second compensation metric; and computing a value for the first compensation metric for one or more users of the computer system based on the first formula and the value of the second compensation metric.

### CROSS-REFERENCE TO RELATED APPLICATIONS

The present invention claims priority benefit to United States provisional patent application titled, “CALCULATION ENGINE FOR COMPENSATION PLANNING,” filed on Nov. 12, 2010 and having Ser. No. 61/413,323, the entire contents of which are incorporated herein by reference.

### BACKGROUND

1. Field of the Invention

The present invention relates to the field of computer software and, in particular, to a calculation engine for compensation planning.

2. Description of the Related Art

One common task performed by an administrator in an enterprise environment is compensation calculation and planning. An enterprise, such as a corporation, may have a unique calculation or process for determining compensation. Oftentimes, it is very difficult to have a one-size-fits-all solution that is serviceable by many different enterprises. Thus, many enterprises use their own proprietary application or process to manage their specific compensation needs. For example, many companies write custom code or scripts to their standard compensation application in order to adapt to a particular calculation need. However, doing so can be tedious and error prone.

Accordingly, there remains a need in the art for a technique that addresses the drawbacks and limitations discussed above.

### SUMMARY

Embodiments of the invention provide a platform to enable a user to define custom formulas for compensation planning process. A compensation engine is disclosed that performs currency conversion and number formatting, as well as a range of functions and advanced lookups. In one embodiment, the compensation engine may process a formula to determine the value of a metric, where the formula includes other formulas. In another embodiment, the compensation engine provides the ability to define conditional if-else statements when defining a formula for a compensation calculation.

One embodiment of the invention provides a method for managing compensation of users. The method includes identifying a first formula that is associated with a first compensation metric, where the first formula includes reference to a second compensation metric; computing a value for the second compensation metric based on evaluating a second formula associated with the second compensation metric; and computing a value for the first compensation metric for one or more users of the computer system based on the first formula and the value of the second compensation metric.

Advantageously, embodiments of the invention provide administrative efficiency when managing compensation.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a networked computer environment in which embodiments of the invention may be practiced.

FIG. 2 is a conceptual diagram illustrating a user interface that includes compensation metrics, according to one embodiment of the invention.

FIGS. 3A-3B are conceptual diagrams illustrating custom compensation metrics, according to various embodiments of the invention.

FIG. 4 is a flow diagram of method steps for displaying compensation metrics, according to one embodiment of the invention.

### DETAILED DESCRIPTION OF EXEMPLARY EMBODIMENTS

Embodiments of the invention provide a platform to enable a user to define custom formulas for compensation planning process. A compensation engine is disclosed that performs currency conversion and number formatting, as well as a range of functions and advanced lookups. In one embodiment, the compensation engine may process a formula to determine the value of a metric, where the formula includes other formulas. In another embodiment, the compensation engine provides the ability to define conditional if-else statements when defining a formula for a compensation calculation.

In one embodiment, a compensation module included in a software application is configured to calculate compensation allocation, metrics, reports, and other organization specific calculations. The compensation module offers industry standard calculations and metrics, and also allows for users to define custom calculations. When defining the custom calculations, the user can define a variety of mathematical operations including logic operations, such as if-then-else statements, as described in greater detail herein.

### Hardware Overview

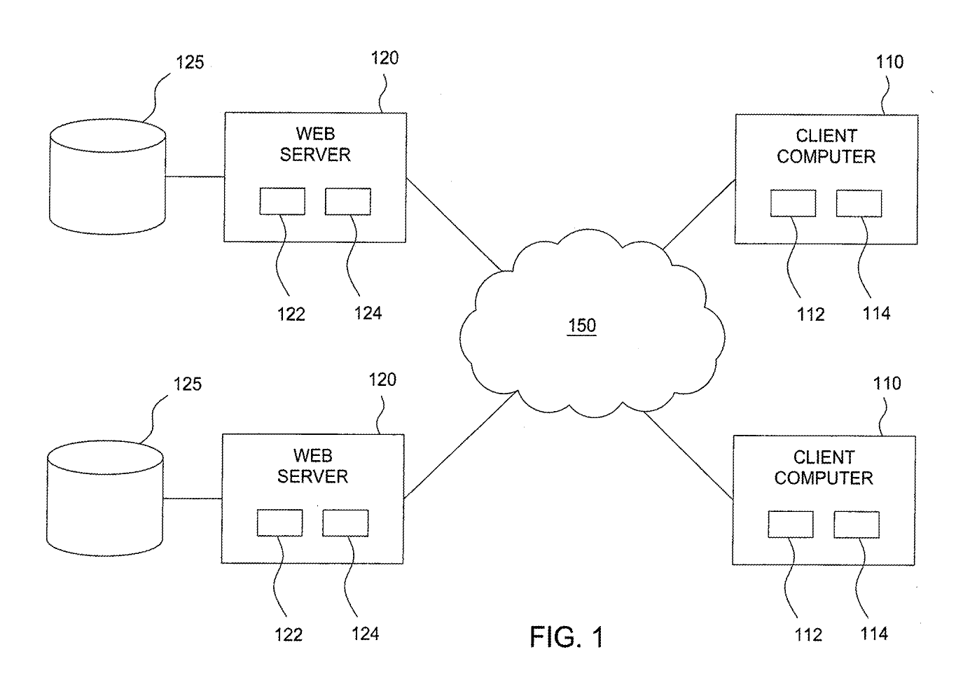

FIG. 1 illustrates a networked computer environment in which embodiments of the invention may be practiced. As shown, the networked computer environment includes a plurality of client computers 110 (only two of which are shown) and a plurality of web servers 120 with associated content storage units 125. The client computers 110 and the web server computers 120 are connected over a computer network 150, e.g., the Internet.

Each client computer 110 includes conventional components of a computing device, e.g., a processor 112, system memory 114, a hard disk drive, input devices such as a mouse and a keyboard, and output devices such as a monitor, among others. Each web server 120 includes a processor 122 and a system memory 124, and manages the contents stored in its respective content storage unit using a relational database software. The web server is programmed to communicate with the client computers 110 and other web servers using the TCP/IP protocol. The client computers 110 are programmed to execute web browser programs and other software applications and access the web pages and/or applications managed by the web servers by specifying a uniform resource locator (URL) for the web server into the browser.

In the embodiments of the present invention described below, users are respectively operating the client computers 110 that are connected to the web servers 120 over the Internet. The web pages that are displayed to a user are transmitted from the web servers 120 to that user's client computer 110 and processed by the web browser program stored in that user's client computer 110 for display through the monitor of that user's client computer 110.

Client computers 110 includes a System 200 may be a personal computer, smart phone, touch pad, touch screen, or any other device suitable for practicing one or more embodiments of the present invention. It should be noted that the present invention can be implemented in hardware, software, or in a combination of hardware and software, e.g., using application specific integrated circuits (ASIC), a general purpose computer or any other hardware equivalents.

### Compensation Calculation

Embodiments of the invention provide a platform to enable a user to define custom formulas for compensation planning process. In one embodiment, a compensation engine can be part of a business execution software application executed by a web server 120 and accessed via a client computer 110.

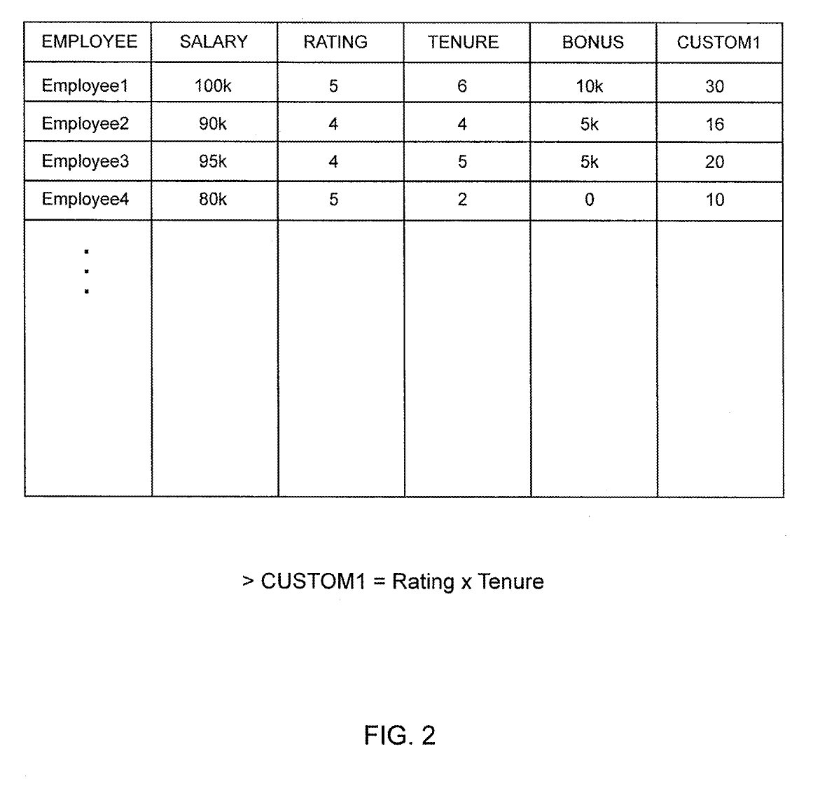

FIG. 2 is a conceptual diagram illustrating a user interface that includes compensation metrics, according to one embodiment of the invention. In one embodiment, individual entities, such as employees in a corporation, are organized in a first column of the user interface. Additional columns in the user interface are associated with different compensation metrics for each individual entity. As shown in FIG. 2, the compensation metrics include salary, rating, tenure, bonus, and a custom metric called “custom1.” In the example shown, the custom1 metric is defined as “rating” multiplied by “tenure.” An administrator, such as a manager or an employee authorized to do compensation planning, can view and edit the data shown in a compensation module of a business execution software platform.

In one embodiment, the compensation module may be pre-configured to include several industry standard metrics in the user interface. Some examples of industry standard metrics include: job title, job level, paygrade, project manger's rating, current salary, job family, job role, promotion, merit, total raise, compensation ratio, total compensation, salary type, bonus total, bonus target, stock, or options, among many others.

In addition to standard compensation metrics, the user interface may include custom metrics. Custom metrics can be defined by the administrator using a mathematical or logical formula. The choice as to which metrics should be displayed in the user interface shown in FIG. 2 may be user configurable. For example, a particular administrator may choose to view the rating metric, whereas another administrator may choose to have the rating metric hidden.

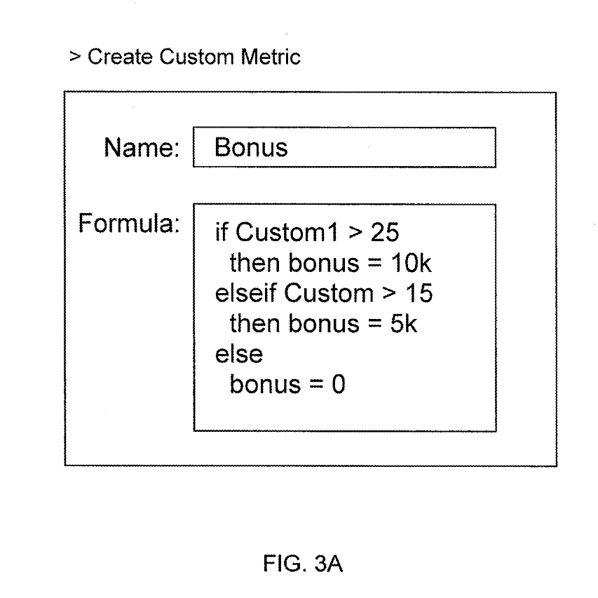

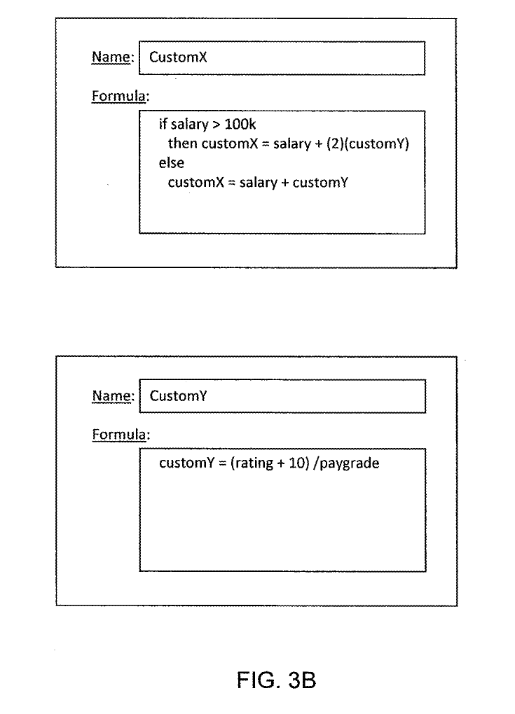

FIG. 3A is a conceptual diagram illustrating a custom compensation metric, according to one embodiment of the invention. As shown, an administrator can define a name and a formula for the custom metric. In some embodiments, the formula may include if-then-else statements. For example, a custom metric “custom1” may be defined as rating multiplied by tenure. Another custom metric called “bonus,” may be defined according to an if-then-else constructions. For example, if the custom1 metric for an individual has a value greater than 25, then the “bonus” of an individual is set to $10,000. If the custom1 metric is not greater than 25, but is greater than 15, then the bonus of an individual is set to $5,000. If the custom1 metric is less than 15, then the bonus of an individual is set to 0. The “bonus” metric is shown in FIG. 2, where Employee1 receives a $10,000 bonus, Employee2 and Employee3 receive $5,000 bonus, and Emplyee4 receives 0 bonus. In some embodiments, user interface elements may be provided that allow the user to select the names of metrics to use in formula creation from a drop-down list or other selection interface.

FIG. 3B is also a conceptual diagram illustrating a custom compensation metric, according to one embodiment of the invention. As shown, an administrator can define a name and a formula for the custom metric. In some embodiments, the formula may include reference to one or more other formulas. For example, a custom metric “customX” may be defined as a function of “salary” and the value of custom metric “customY.” The custom metric “customY” may be defined by a function of “rating” and “paygrade.”

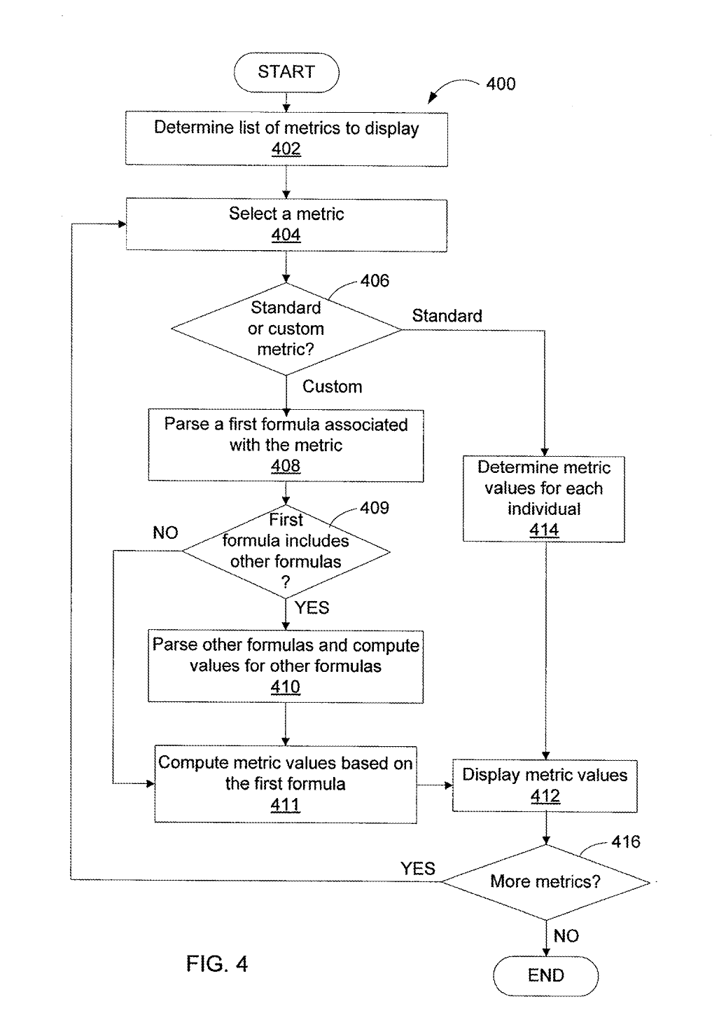

FIG. 4 is a flow diagram of method steps for displaying compensation metrics, according to one embodiment of the invention. Persons skilled in the art will understand that, even though the method 400 is described in conjunction with the systems of FIGS. 1-3B, any system configured to perform the method steps, in any order, is within the scope of embodiments of the invention.

As shown, the method 400 begins at step 402, where a software application, such as a business execution software application executed by a processor, determines a list of metrics to display. The list of metrics may be a default list or the list of metrics may be configurable. At step 404, the software application selects a metric from the list of metrics. At step 406, the software application determines whether the metric is a standard metric or a custom metric.

If the software application determines that the metric is a custom metric, then the method proceeds to step 408. At step 408, the software application parses a first formula associated with the metric. As described, the custom metric may include a mathematical and/or logical formula that defines the calculation for the custom metric. At step 409, the software application determines whether the first formula includes reference other formulas. As described above, in some embodiments, the calculation for a particular metric may reference other standard metrics or other custom-defined metrics that may include additional formulas. If, at step 409, the software application determines that the first formula includes other formulas, then the method 400 proceeds to step 410, where the software application parses the other formulas and computes values for the other formulas. The method then proceeds to step 412. If, at step 409, the software application determines that the first formula does not include other formulas, then the method 400 proceeds to step 412.

At step 412, the software application computes values for the metric for each individual based on the first formula. Computing the values may involve looking up standard or custom metric values referenced in the first formula. At step 414, the software application displays the metric values. For example, the values may be displayed in a table format as shown in FIG. 2.

If, at step 406, the software application determines that the metric is a standard metric, then the method proceeds to step 414. At step 414, the software application determines values for each individual for the metric. In one embodiment, when the metric is a standard metric, determining the values involves a lookup operation. For example, the lookup may be performed into a database of employee specific data. In some embodiments, computations are performed to determine the values of the standard metric. The method then proceeds to step 412, described above.

At step 416, the software application determines whether any additional metrics are left to be analyzed. If so, the method 400 returns to step 404, described above. If not, then the method 400 terminates. Again, the choice of which metrics are displayed is, in some embodiments, user configurable.

In some embodiments, the table of metric values (such as, for example, shown in FIG. 2) may include modifiable fields. Modifying one field in the table may, in some embodiments, change the value of one or more other fields that depend on the modified field. For example, if a “total compensation” metric is based on a “salary” metric and a “bonus” metric, then modifying the value of the salary metric for a particular individual would cause the value of the total compensation metric to also change for that particular individual. Compensation administrators can use this feature to manually modify the values of certain metrics via “trial-and-error” and can see the results of those modifications in the overall compensation model.

Also, in some embodiments, the formula for a particular metric may include rounding within the formula. For example, the compensation engine may be configured to round certain values up to the nearest integer, down to the nearest integer, to the closest integer (ties round up or ties round down), to the nearest half-integer, or any other rounding scheme.

In sum, embodiments of the invention provide a platform to enable a user to define custom formulas for compensation planning process. A compensation engine is disclosed that performs currency conversion and number formatting, as well as a range of functions and advanced lookups. One such function is the ability for the user to define custom formulas and/or conditional if-else statements when defining a formula for a compensation calculation.

Advantageously, embodiments of the invention provide administrative efficiency when managing compensation.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

What is claimed is:

1. A method for managing compensation of users, the method comprising:
identifying a first formula that is associated with a first compensation metric, wherein the first formula includes reference to a second compensation metric;
computing a value for the second compensation metric based on evaluating a second formula associated with the second compensation metric; and
computing a value for the first compensation metric for one or more users of the computer system based on the first formula and the value of the second compensation metric.

2. The method according to claim 1, further comprising:
receiving a user input that manually modifies a value of a third compensation metric associated with a first user; and
computing a modified value for a fourth compensation metric associated with the first user based on the user input and a formula for the fourth compensation metric that references the third compensation metric.

3. The method according to claim 1, wherein the first formula further includes a conditional in-then-else statement used for computing the value for the first compensation metric.

4. The method according to claim 1, wherein the first formula includes reference to one or more compensation metrics selected from the list of: job title, job level, paygrade, project manger's rating, current salary, job family, job role, promotion, merit, total raise, compensation ratio, total compensation, salary type, bonus total, bonus target, stock, or options.

5. The method according to claim 1, wherein the first formula includes reference to a numeric value that is rounded to the nearest integer.

6. The method according to claim 1, further comprising displaying, for each of the one or more users, the value for the first compensation metric corresponding to the user in a table.

7. The method according to claim 1, wherein the first formula is based on at least two of a value for salary, a value for bonus, and a value associated with stocks.

8. A non-transitory computer-readable storage medium storing instructions that, when executed by a processor, cause a computer system to manage compensation of users, by performing the steps of:
identifying a first formula that is associated with a first compensation metric, wherein the first formula includes reference to a second compensation metric;
computing a value for the second compensation metric based on evaluating a second formula associated with the second compensation metric; and
computing a value for the first compensation metric for one or more users of the computer system based on the first formula and the value of the second compensation metric.

9. The computer-readable storage medium according to claim 8, further comprising:
receiving a user input that manually modifies a value of a third compensation metric associated with a first user; and
computing a modified value for a fourth compensation metric associated with the first user based on the user input and a formula for the fourth compensation metric that references the third compensation metric.

10. The computer-readable storage medium according to claim 8, wherein the first formula further includes a conditional in-then-else statement used for computing the value for the first compensation metric.

11. The computer-readable storage medium according to claim 8, wherein the first formula includes reference to one or more compensation metrics selected from the list of: job title, job level, paygrade, project manger's rating, current salary, job family, job role, promotion, merit, total raise, compensation ratio, total compensation, salary type, bonus total, bonus target, stock, or options.

12. The computer-readable storage medium according to claim 8, wherein the first formula includes reference to a numeric value that is rounded to the nearest integer.

13. The computer-readable storage medium according to claim 8, further comprising displaying, for each of the one or more users, the value for the first compensation metric corresponding to the user in a table.

14. The computer-readable storage medium according to claim 8, wherein the first formula is based on at least two of a value for salary, a value for bonus, and a value associated with stocks.

15. A graphical user interface of a software application for managing compensation of users, the graphical user interface comprising:
a first portion that includes a listing of one or more users; and
a second portion that includes values for one or more compensation metrics associated with each of the one or more users, wherein the software application is configured to:
identify a first formula that is associated with a first compensation metric, wherein the first formula includes reference to a second compensation metric,
compute a value for the second compensation metric based on evaluating a second formula associated with the second compensation metric,
compute a value for the first compensation metric for each of the one or more users based on the first formula and the value of the second compensation metric, and
for each of the one or more users, display the value for the first compensation metric in the first portion of the graphical user interface.

16. The graphical user interface according to claim 15, wherein the software application is further configured to:
receive a user input that manually modifies a value of a third compensation metric associated with a first user; and
compute a modified value for a fourth compensation metric associated with the first user based on the user input and a formula for the fourth compensation metric that references the third compensation metric.

17. The graphical user interface according to claim 15, wherein the first formula further includes a conditional in-then-else statement used for computing the value for the first compensation metric.

18. The graphical user interface according to claim 15, wherein the first formula includes reference to one or more compensation metrics selected from the list of: job title, job level, paygrade, project manger's rating, current salary, job family, job role, promotion, merit, total raise, compensation ratio, total compensation, salary type, bonus total, bonus target, stock, or options.

19. The graphical user interface according to claim 15, wherein the first formula includes reference to a numeric value that is rounded to the nearest integer.

20. The graphical user interface according to claim 15, further comprising displaying, for each of the one or more users, the value for the first compensation metric corresponding to the user in a table.
